(19) United States
(12) Patent Application Publication
(10) Pub. No.: US 2025/0234151 A1
(43) Pub. Date: Jul. 17, 2025

(54) ELECTRONIC DEVICE AND METHOD FOR OUTPUTTING SOUND THEREOF

(71) Applicant: SAMSUNG ELECTRONICS CO., LTD., Suwon-si (KR)

(72) Inventors: Donghyun LIM, Suwon-si (KR); Woojung LEE, Suwon-si (KR); Yoonjae LEE, Suwon-si (KR); Sunmin KIM, Suwon-si (KR); Haekwang PARK, Suwon-si (KR)

(73) Assignee: SAMSUNG ELECTRONICS CO., LTD., Suwon-si (KR)

(21) Appl. No.: 19/097,233

(22) Filed: Apr. 1, 2025

Related U.S. Application Data
(63) Continuation of application No. PCT/KR2023/018185, filed on Nov. 13, 2023.

(30) Foreign Application Priority Data
Nov. 16, 2022 (KR) 10-2022-0153458

(51) Int. Cl. H04S 7/00; H04R 3/00; H04R 3/12; H04R 5/02; H04R 5/027; H04S 1/00

(52) U.S. Cl. CPC H04S 7/303; H04R 3/005; H04R 3/12; H04R 5/02; H04R 5/027; H04S 1/007; H04S 2400/11; H04S 2400/15

(57) ABSTRACT

An electronic device includes a speaker array, a microphone array including a plurality of microphones, a memory, and one or more processors. The one or more processors are configured to, identify a user direction based on a user voice received through the plurality of microphones, based on the user direction being identified as a front direction of the electronic device, control the speaker array to output a sound signal in a first output mode, and based on the user direction being identified as not the front direction of the electronic device, control the speaker array to output a sound signal in a second output mode. The first output outputs an R-channel signal and an L-channel signal using beamforming and the second output mode uses the R-channel signal and the L-channel signal to provide a sound field having a wider sweet spot than in the first output mode.

### CROSS-REFERENCE TO RELATED APPLICATION

This application is a continuation application is a continuation application, under 35 U.S.C. § 111(a), of international application No. PCT/KR2023/018185, filed Nov. 3, 2023, which claims priority under 35 U.S.C. § 119 to Korean Patent Application No. 10-2022-0153458, filed Nov. 16, 2022, the disclosures of which are incorporated herein by reference in their entireties.

### TECHNICAL FIELD

The present disclosure relates to an electronic device and a method for outputting sound thereof, and more particularly to, an electronic device including a plurality of speaker units and a method for outputting sound thereof.

### BACKGROUND ART

With the development of electronic technology, various types of electronic devices are being developed. In particular, in order to meet the needs of users who want newer and more diverse functions, sound output devices are being developed to provide sound that corresponds to the characteristics of various contents.

### DISCLOSURE

### Technical Solution

An electronic device according to an embodiment includes a speaker array, a microphone array including a plurality of microphones, a memory to store at least one instruction, and one or more processors connected to the speaker array, the microphone array and the memory to control the electronic device. The one or more processors are configured to, by executing the at least one instruction, identify a user direction based on a user voice of a user that is received through the plurality of microphones, based on the user direction being identified as a front direction of the electronic device, control the speaker array to output a sound signal in a first output mode, and based on the user direction being identified as not a front direction of the electronic device, control the speaker array to output a sound signal in a second output mode, and the first output mode is a mode in which an R-channel signal and an L-channel signal are output using beamforming and the second output mode is a mode in which the R-channel signal and the L-channel signal are used to provide a sound field having a wider sweet spot than in the first output mode.

The one or more processors may be configured to, based on identifying that the user direction is a front direction of the electronic device, control the speaker array to directionally output an R-channel signal toward a right ear of the user and directionally output an L-channel signal toward a left ear of the user using the beamforming.

The one or more processors may be configured to, based on identifying that the user direction is a front direction of the electronic device, identify a distance between the electronic device and the user, and control the speaker array to output an R-channel signal and an L-channel signal through the beamforming according to the identified distance.

The one or more processors may be configured to, based on identifying that the user direction is a front direction of the electronic device, control the speaker array to output a detection signal, and identify a distance between the electronic device and the user based on a time at which the output detection signal is received through the plurality of microphones and a time at which the output detection signal is reflected by the user and received through the plurality of microphones.

The one or more processors may be configured to control the speaker array to directionally output the detection signal toward a front direction of the electronic device through the beamforming.

The memory may include a plurality of beamforming filter sets corresponding to a plurality of distances, and the one or more processors may be configured to identify a beamforming filter set corresponding to the identified distance among the plurality of beamforming filter sets, input the R-channel signal and the L-channel signal to a plurality of beamforming filters included in the identified beamforming filter set, and output an R-channel signal and an L-channel signal that passed through the plurality of beamforming filters through the speaker array, and a beam width and a beam angle of the R-channel signal and the L-channel signal may be determined according to a beamforming filter set corresponding to the identified distance.

The speaker array may include a plurality of speaker units, and the plurality of speaker units may include a plurality of tweeter units that output a high-range sound signal above a threshold frequency and a plurality of mid-range units that output a low-and mid-range sound signal below the threshold frequency.

The plurality of tweeter units may include a plurality of first tweeter units disposed in a center portion of the speaker array and a plurality of second tweeter units disposed spaced apart to the right and left of the plurality of first tweeter units, and the plurality of mid-range units may be disposed on one side of the plurality of second tweeter units.

The plurality of first tweeter units may include a plurality of tweeter units that are disposed in a row, the plurality of second tweeter units may include a left tweeter unit disposed to the left of the plurality of first tweeter units and a right tweeter unit disposed to the right of the plurality of first tweeter units, and the plurality of mid-range units may include a first mid-range unit disposed to the left of the left tweeter unit and a second mid-range unit disposed to the right of the right tweeter unit.

A method for outputting sound of an electronic device that includes a speaker array and a microphone array including a plurality of microphones according to an embodiment includes identifying a user direction based on a user voice received through the plurality of microphones, and based on the user direction being identified as a front direction of the electronic device, controlling the speaker array to output a sound signal in a first output mode, and based on the user direction being identified as not a front direction of the electronic device, controlling the speaker array to output a sound signal in a second output mode, and the first output mode is a mode in which an R-channel signal and an L-channel signal are output using beamforming and the second output mode is a mode in which the R-channel signal and the L-channel signal are used to provide a sound field having a wider sweet spot than in the first output mode.

In a non-transitory computer-readable recording medium storing a computer instruction that, when executed by one or more processors of an electronic device that includes a speaker array and a microphone array including a plurality of microphones, causes the electronic device to, identify a user direction based on a user voice received through the plurality of microphones, based on the user direction being identified as a front direction of the electronic device, control the speaker array to output a sound signal in a first output mode, and based on the user direction being identified as not a front direction of the electronic device, control the speaker array to output a sound signal in a second output mode, and the first output mode is a mode in which an R-channel signal and an L-channel signal are output using beamforming and the second output mode is a mode in which the R-channel signal and the L-channel signal are used to provide a sound field having a wider sweet spot than in the first output mode.

### DESCRIPTION OF DRAWINGS

FIGS. 1A and 1B are views illustrating an implementation example of an electronic device according to an embodiment;

FIG. 2A is a block diagram illustrating configuration of an electronic device according to an embodiment;

FIG. 2B is a block diagram illustrating an implementation example of an electronic device according to an embodiment;

FIG. 3 is a flowchart provided to explain a method for outputting sound of an electronic device according to an embodiment;

FIG. 4 is a view provided to explain a user direction according to an embodiment;

FIG. 5 is a view provided to explain a method for an electronic device to output a sound signal in a second output mode according to an embodiment;

FIGS. 6 and 7 are views provided to explain a method for an electronic device to output a sound signal based on a distance between the electronic device and a user according to an embodiment;

FIG. 8 is a view provided to explain an example in which a detection signal output by an electronic device is received through a plurality of microphones according to an embodiment; and

FIG. 9 is a view provided to explain an example in which a beam is formed according to an embodiment.

### DETAILED DESCRIPTION OF EMBODIMENTS

The terms used in this specification will be described briefly and the present disclosure will be described in detail.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Therefore, the terms used in the embodiments of the disclosure need to be defined on the basis of the meanings of the terms and the overall contents throughout the disclosure rather than simple names of the terms.

In the disclosure, the expressions “have”, “may have”, “include” or “may include” indicate existence of corresponding features (e.g., components such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

In some cases, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor (not shown) except for a ‘module’ or a ‘unit’ that needs to be implemented as specific hardware.

Meanwhile, various elements and areas in the drawings are schematically drawn in the drawings. Therefore, the technical concept of the disclosure is not limited by a relative size or spacing drawn in the accompanying drawings.

Hereinafter, an embodiment of the present disclosure will be described in greater detail with reference to the accompanying drawings.

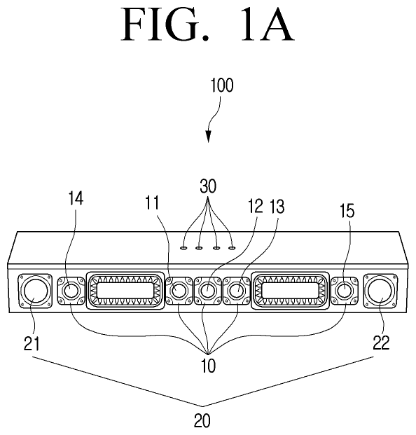

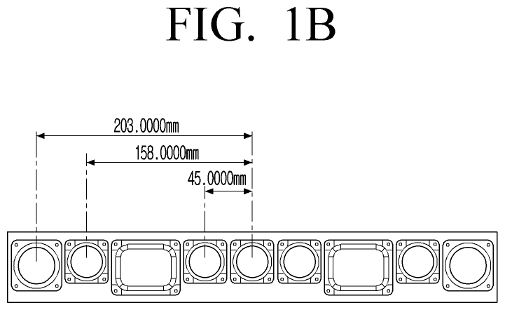

FIGS. 1A and 1B are views illustrating an implementation example of an electronic device according to an embodiment.

An electronic device 100 may include a speaker array including a plurality of speaker units. In this case, the electronic device 100 may be implemented as soundbar, home theater system, one box speaker, room speaker, front surround speaker, etc. However, the electronic device 100 is not limited thereto, and any device including a plurality of speaker units can be the electronic device 100 according to the present disclosure. For example, the electronic device 100 may be implemented as a TV, an audio device, a user terminal, etc. having a plurality of speaker units.

The plurality of speaker units included in the electronic device 100 may have the function of converting electric pulses into sound waves, and may be implemented as a coin type, that is, a dynamic type which is distinguished according to the principle and method of converting electric signals into sound waves. However, the plurality of speaker units are not limited thereto, and the plurality of speaker units may be implemented as a capacitive type, a dielectric type, a magnetostrictive type, etc. within the scope to which the present disclosure is applied.

In addition, the electronics 100 may be implemented in a multi-way manner that divides

the playback band into low/mid/high sound ranges, and distributes the divided ranges to suitable speaker units.

For example, in the case of a 2-way manner that distributes the playback band to two types of speakers, the plurality of speaker units may be implemented in a form that includes a tweeter unit and a mid-range unit.

For example, in the case of a three-way manner that distributes the playback band to three types of speakers, the plurality of speaker units may be implemented in a form that includes a tweeter unit for reproducing high-frequency sound signals, a mid-range unit for reproducing mid-frequency sound signals, and at least one woofer unit for reproducing low-frequency sound signals.

FIG. 1A is a view illustrating an implementation example of the electronic device 100.

As shown in FIG. 1A, the plurality of speaker units included in the electronic device 100 may include a plurality of tweeter units 10 that reproduce sound signals of a high frequency band, i.e., high-range sound signals, and a plurality of mid-range units 20 that reproduce sound signals of an intermediate frequency band and a low frequency band, i.e., low-and mid-range sound signals.

For example, the plurality of tweeter units 10 may include a plurality of first tweeter units 11, 12, 13 disposed in a center portion of the speaker array and a plurality of second tweeter units 14, 15 spaced apart to the right and left of the plurality of first tweeter units 11, 12, 13.

In this case, the plurality of first tweeter units 11, 12, 13 may include three tweeter units 11, 12, 13 disposed in a row. The plurality of second tweeter units 14, 15 may include a right tweeter unit 14 disposed to the right of the three tweeter units 11, 12, 13 and a left tweeter unit 15 disposed to the left of the three tweeter units 11, 12, 13. IN other words, the right tweeter unit 14 may be disposed to the right of the rightmost tweeter unit 11 among the three tweeter units 11, 12, 13 disposed in the center portion of the speaker array, and the left tweeter unit 15 may be disposed to the left of the leftmost tweeter unit 13 among the three tweeter units 11, 12, 13 disposed in the center portion of the speaker array. However, the number and/or placement of the plurality of tweeter units is not necessarily limited thereto.

The plurality of mid-range units 21, 22 may be disposed on one side of the plurality of second tweeter units 14, 15. In this case, the plurality of mid-range units 21, 22 may include a first mid-range unit 21 disposed to the right of the right tweeter unit 14 and a second mid-range unit 22 disposed to the left of the left tweeter unit 15. However, the number and placement of the plurality of mid-range units is not necessarily limited thereto.

The electronic device 100 may include a microphone array 30 including a plurality of microphones. The microphone array 30 may be implemented such that the plurality of microphones are disposed at regular intervals. Meanwhile, although FIG. 1A illustrates that the microphone array 30 includes four microphones, but it is not limited thereto. According to an embodiment, the microphone array 30 may be used to identify a user direction.

FIG. 1B is a view illustrating implementation figures of a speaker array according to an embodiment.

According to an embodiment, the electronic device 100 may include a small volume speaker array. For example, the distance between each speaker unit may be as shown in FIG. 1B, but is not necessarily limited thereto.

Meanwhile, recently, the use of content such as metaverse, VR, games, and personal video upload content that can provide a user with stereoscopic sound through a private audio output device such as headphone/headset/earphone is increasing.

When a user uses a private audio output device, the left (L) channel signal enters only the user's left ear, and conversely, the right (R) channel signal enters only the user's right ear. For example, in the case of Binaural Audio Contents, a perfect stereoscopic sound experience is possible when listening with a private audio output device.

Meanwhile, in the case of a general speaker, the signal of the L-channel (or R-channel) enters not only the user's left ear but also the right ear. This phenomenon is known as crosstalk, which can reduce the effect of stereoscopic sound.

Hereinafter, various embodiments that can effectively eliminate crosstalk to maximize the stereoscopic effect in a small volume speaker array will be described.

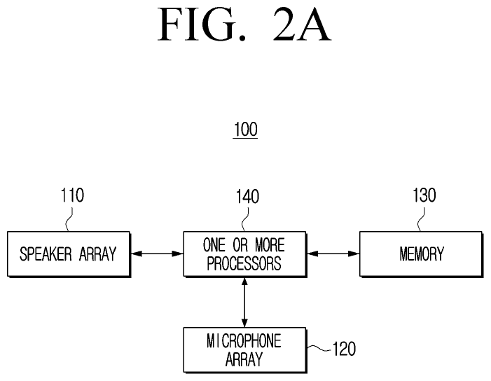

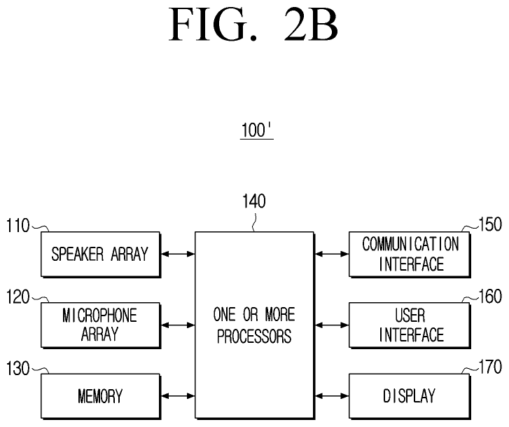

FIG. 2A is a block diagram illustrating configuration of an electronic device according to an embodiment.

According to FIG. 2A, the electronic device 100 includes a speaker array 110, a microphone array 120, memory 120, and one or more processors 140.

The speaker array 110 includes a plurality of speaker units. In one example, as shown in FIG. 1A, the plurality of speaker units may include a plurality of tweeter units 10 and a plurality of mid-range units 20. These have been described in detail in FIG. 1A, so further description will be omitted.

The microphone array 120 may receive a user voice or other sound and convert it into audio data.

In this case, the microphone array 120 may include a plurality of microphones. According to an embodiment, the speaker array 120 may be implemented as the microphone array 30 illustrated in FIG. 1A, and may be disposed in a preset location of the electronic device 100, for example, in the center portion.

The memory 130 may store data required for various embodiments of the present disclosure. The memory 130 may be implemented as a memory embedded in the electronic device 100 or as a memory detachable from the electronic device 100 depending on the data storage purpose. For example, in the case of data for driving the electronic device 100, the data may be stored in the memory embedded in the electronic device 100, and in the case of data for the expansion function of the electronic device 100, the data may be stored in the memory detachable from the electronic device 100.

Meanwhile, the memory embedded in the electronic device 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the electronic device 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

The one or more processors 140 control the overall operations of the electronic device 100. Specifically, the one or more processors 140 are connected to each component of the electronic device 100 to control the overall operations of the electronic device 100. For example, the one or more processors 140 may be electrically connected to the speaker array 110, the microphone array 120 and the memory 130 to control the overall operations of the electronic device 100. The one or more processors 140 may consist of one or multiple processors.

The one or more processors 140 may execute at least one instruction stored in the memory 130 to perform the operations of the electronic device 100 according to various embodiments.

The one or more processors 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 140 may control one or any combination of the other components of the electronic device, and may perform communication-related operations or data processing. The one or more processors 130 may execute one or more programs or instructions stored in the memory. For example, the one or more processors may perform a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 140 may be implemented as a single core processor including a single core, or as one or more multicore processors including a plurality of cores (e.g., homogeneous multicore or heterogeneous multicore). When the one or more processors 140 are implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which at least one processor and other electronic components are integrated, a single-core processor, a multi-core processor, or a core included in a single-core processor or multi-core processor, and here, the core may be implemented as CPU, GPU, APU, MIC, DSP, NPU, hardware accelerator, or machine learning accelerator, etc., but the core is not limited to the embodiments of the present disclosure. Hereinafter, for convenience of explanation, the one or more processors 140 will be referred to as the processor 140.

FIG. 2B is a block diagram illustrating an implementation example of an electronic device according to an embodiment.

Referring to FIG. 2B, an electronic device 100′ may include the speaker array 110, the microphone array 120, the memory 130, the one or more processors 140, a communication interface 150, a user interface 160, and a display 170. and a microphone array 140. However, such configurations are only exemplary, and new configurations may be added to the above configurations or some configurations may be omitted in practicing the present disclosure. Meanwhile, a detailed description of the configurations shown in FIG. 2B that overlap with the configurations shown in FIG. 2A will be omitted.

The communication interface 150 includes circuitry. In addition, the communication interface 150 may support various communication methods depending on the implementation example of the electronic device 100.

For example, the communication interface 150 may perform communication with an external device, an external storage medium (e.g. USB memory), an external server (e.g., cloud server), etc. through a communication method such as Bluetooth, access point (AP)-based wireless fidelity (Wi-Fi, wireless local area network (LAN)), Zigbee, wired/wireless local area network (LAN), wide area network (WAN), Ethernet, IEEE 1394, high definition multimedia interface (HDMI), Universal Serial Bus (USB), mobile high-definition link (MHL), audio engineering society/European broadcasting union (AES/EBU) communication, optical communication, coaxial communication, etc.

In this case, the communication interface 150 may receive data from an external device, a server, or the like, and may transmit data to the external device, the server, or the like. For example, the communication interface 150 may receive sound signals including R-channels and L-channels. Here, the sound signals may be stereo signals or multichannel signals.

The user interface 160 includes circuitry. The user interface 160 may receive a user command. To this end, the user interface 160 may be implemented as a device such as a button, a touch pad, a mouse, and a keyboard, or a touch screen that can also perform a display function and a manipulation input function.

The display 170 may be implemented as a display including a self-luminous element or a display including a non-luminous element and a backlight.

For example, the display 170 may be implemented as various types of displays such as a Liquid Crystal Display (LCD), an Organic Light Emitting Diodes (OLED) display, a Light Emitting Diodes (LED), a micro LED, a Mini LED, a Plasma Display Panel (PDP), a Quantum dot (QD) display, a Quantum dot light-emitting diodes (QLED), etc. The display 170 may also include a driving circuit, a backlight unit, and the like, which may be implemented in the form of a-si TFTs, low temperature poly silicon (LTPS) TFTs, organic TFTs (OTFTs), and the like.

According to an embodiment, a touch sensor for detecting various types of touch inputs may be disposed on the front of the display 170.

For example, the display 170 may detect various types of touch inputs, such as a touch input by a user's hand, a touch input by an input device such as a stylus pen, a touch input by certain capacitive materials, and the like. Here, the input device may be implemented as a pen-like input device, which may be referred to by various terms, such as an electronic a pen, a stylus pen, a S-pen, etc. According to an embodiment, the display 170 may be implemented as a flat display, a curved display, a flexible display capable of folding and/or rolling, and the like.

In addition, the electronic device 100″ may further include a camera (not shown), a sensor (not shown), a tuner (not shown), and a demodulator (not shown), depending on implementation examples.

According to an embodiment, the processor 140 identifies the user direction.

When it is identified that the user direction is the front direction of the electronic device 100, the processor 140 controls the speaker array 110 to output a sound signal in the first output mode. Here, the first output mode is a mode in which R-channel signals and L-channel signals are output using beamforming.

Further, when it is identified that the user direction is not the front direction of the electronic device 100, the processor 140 controls the speaker array 110 to output a sound signal in the second output mode. Here, the second output mode is a mode in which R-channel signals and L-channel signals are output without beamforming.

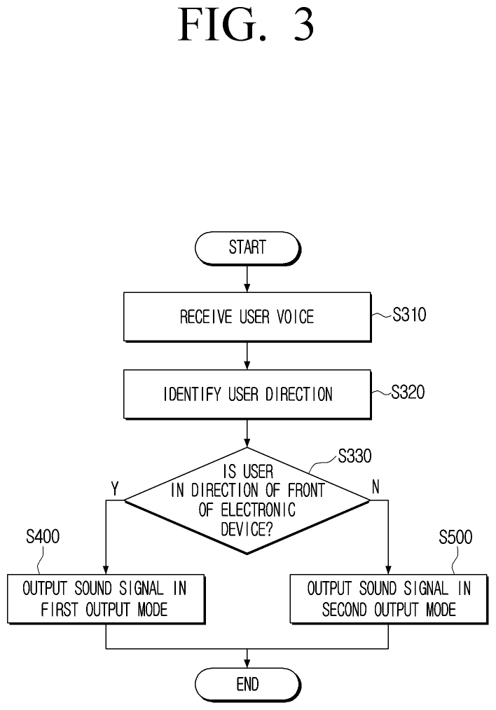

FIG. 3 is a flowchart provided to explain a method for outputting sound of an electronic device according to an embodiment.

Referring to FIG. 3, the processor 140 may receive a user voice through a plurality of microphones included in the microphone array 120 (S310).

In this case, the user voice may include at least one of a random utterance or a preset trigger word.

For example, the user may make an utterance to use a voice chat, an AI voice service, or the like, and in this case, a user voice may be received through a plurality of microphone units. Meanwhile, as described later, the user voice may be used to identify the user direction in the electronic device 100. In this case, the preset trigger word may include a predefined word, sentence, or the like for detecting the user direction in the electronic device 100.

Further, the processor 140 may identify the user direction based on the user voice received through the plurality of microphones (S320).

Here, the user direction may refer to information about the direction in which the user who uttered the user voice is located with reference to the electronic device 100. For example, the user direction may be an angle at which the user is positioned with reference to the electronic device 100. Here, the user's angle may be in the form in which when the angle that is horizontal to the electronic device 100 is 0 degrees, the angle increases clockwise or counterclockwise up to 360 degrees (same as 0 degrees), but is not limited thereto. For example, the user's angle may be in the form in which when the angle in the front direction of the electronic device 100 is 0 degrees and the clockwise direction is +direction and the counterclockwise direction is −direction, the angle increases up to 180 degrees.

In this case, the processor 140 may identify the user direction using, for example, a Direction of Arrival (DOA) technique.

Here, the DOA technique is a technique for obtaining direction information about a voice signal by utilizing the correlation between voice signals received through each of the plurality of microphones included in the microphone array 120. Specifically, according to the DOA technique, when a voice signal is received at a specific incident angle through the plurality of microphones, the processor 140 may obtain the incident angle of the voice signal based on a delay distance and a delay time according to a difference in the distance at which the voice signal arrives at each microphone, and obtain direction information about the received voice signal based on the obtained incident angle.

For example, the processor 140 may delay voice signals received through the plurality of microphones, and calculate a cross-correlation value between the delayed voice signals. In this case, the processor 140 may determine a delay time at which the cross-correlation value is maximized. The processor 140 may estimate the incident angle of a voice signal using the determined delay time, the speed of the voice signal (e.g., speed of sound), and the distance between the microphones.

For example, the processor 140 may determine the direction in which the voice signal is received based on a time difference between a first reception time at which the voice signal in a specific direction is received by a first microphone and a second reception time at which the voice signal is received by a second microphone. To this end, the memory 130 may store pre-measured correlation data between the reception time difference and the reception direction. For example, the processor 140 may obtain a specific direction (e.g., “90 degrees”) corresponding to the corresponding reception time difference among all directions (directions between “0 degrees” and “360”) from the correlation data based on the reception time difference (e.g., 0 seconds) between the first reception time and the second reception time.

In addition, the processor 140 may obtain direction information about a voice signal using various incident angle estimation algorithms, such as Multiple signal Classification (MUSIC), Generalized Cross Correlation with Phase Transform (GCCPHAT), etc.

Further, the processor 140 may identify whether the user direction is the front direction of the electronic device 100.

Here, the front direction of the electronic device 100 may be a direction in which the angle is 90 degrees clockwise when the angle horizontal to the electronic device 100 is 0 degrees.

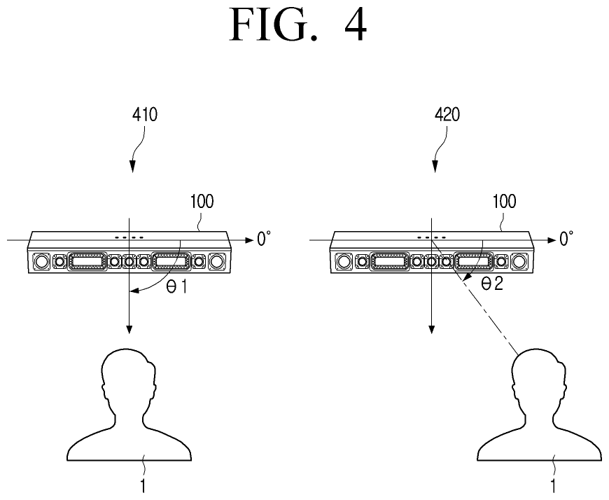

For example, it is assumed that the user 1 is positioned at points with angles θ1 and θ2 clockwise from the horizontal axis with respect to the electronic device (100) as illustrated in 410 and 420 of FIG. 4, respectively. Here, it is assumed that the angle of the horizontal axis is 0 degrees

In this case, when θ1 is 90 degrees in 410 of FIG. 4, the processor 140 may identify that the direction of the user 1 is the front direction of the electronic device 100. Alternatively, when θ2 is 40 degrees at 420 in FIG. 4, the processor 140 may identify that the direction of the user 1 is not the front direction of the electronic device 100.

Meanwhile, in the above embodiment, the front direction of the electronic device 100 is described as a direction 90 degrees from the electronic device 100. However, this is only an example, and when the measured user's angle falls within a preset angle range (e.g., 90 degrees−θ<user's angle<90 degrees+θ), the processor 140 may identify that the user direction is the front direction of the electronic device 100. Here, θ may be preset at the manufacturing stage of the electronic device 100.

Subsequently, when it is identified that the user direction is the front direction of the electronic device 100 (S330-Y), the processor 140 may control the speaker array 110 to output a sound signal in the first output mode (S400).

Here, the first output mode is a mode in which R-channel signals and L-channel signals are using beamforming.

Specifically, when it is identified that the user direction is the front direction of the electronic device 100, the processor 140 may control the speaker array 110 to directionally output R-channel signals toward the user's right ear and L-channel signals toward the user's left ear using beamforming.

Accordingly, when the user is positioned in the front direction of the electronic device 100, the R-channel signals enter the user's right ear and the L-channel signals enter the user's left ear, thereby providing a stereoscopic sound effect to the user.

Meanwhile, when it is identified that the user direction is not the front direction of the electronic device 100 (S330-N), the processor 140 may control the speaker array 110 to output a sound signal in the second output mode (S500).

Here, the second output mode is a mode in which R-channel signals and L-channel signals are output without beamforming.

For example, when it is identified that the direction of the user 1 is the front direction of the electronic device 100, the processor 140 may output a mono sound signal through a plurality of speaker units included in the speaker array 110. In this case, the processor 140 may synthesize R-channel signals and L-channel signals to generate a mono sound signal corresponding to a mono channel, and output the mono sound signal through the plurality of tweeter units 10 and the plurality of midrange units 20.

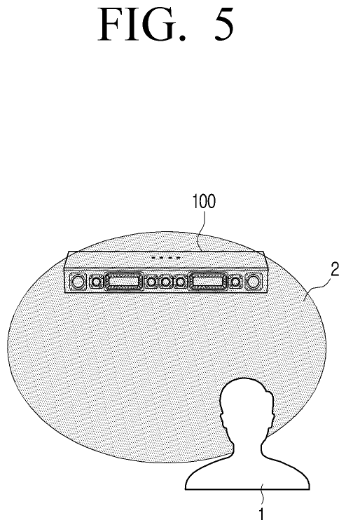

Referring to FIG. 5, when the user 1 is not positioned in the front direction of the electronic device 100, the electronic device 100 may output a mono sound signal 2 with a wide sweet spot. Accordingly, when the user is not positioned in the front direction of the electronic device 100, it is possible to provide a natural sound effect without crosstalk.

Meanwhile, in the above embodiment, it is described that the electronic device 100 outputs a mono sound signal, but this is only an example, and the electronic device 100 may output various types of sound signals that can form a sound field with a wide sweet spot.

Meanwhile, according to an embodiment, when the user is positioned in the front direction of the electronic device 100, the electronic device 100 may effectively eliminate crosstalk by forming an appropriate sound field using beamforming based on the distance between the electronic device 100 and the user.

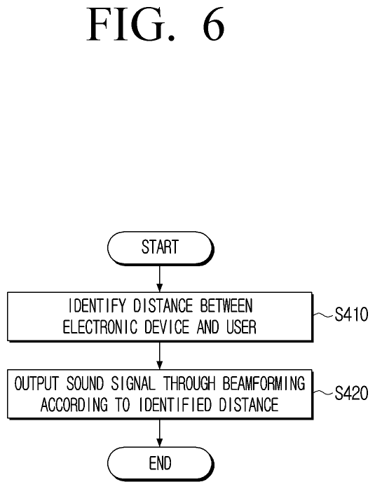

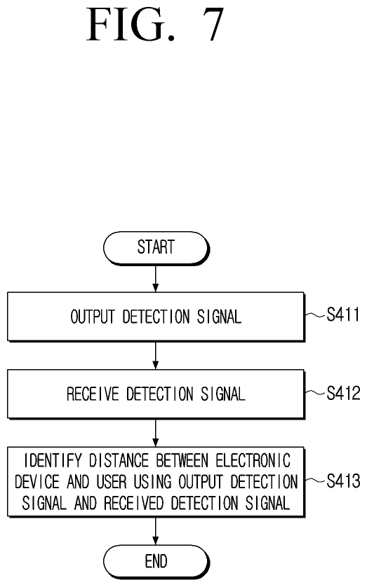

FIGS. 6 and 7 are views provided to explain a method for an electronic device to output a sound signal based on a distance between the electronic device and a user according to an embodiment.

Referring to FIG. 6, when it is identified that the user direction is the front direction of the electronic device 100, the processor 140 may identify the distance between the electronic device 100 and the user (S410).

Specifically, referring to FIG. 7, when it is identified that the user direction is the front direction of the electronic device 100, the processor 140 may control the speaker array 110 to output a detection signal (or detection sound wave signal) (S411).

Here, the detection signal may be a signal that is used to measure the distance between the electronic device 100 and the user. The detection signal may be implemented as a high frequency signal or a signal in an inaudible band so as not to interfere with the user's hearing of sound signals.

Specifically, the processor 140 may output a detection signal through the plurality of tweeter units 10 using beamforming. Specifically, the processor 140 may control the plurality of tweeter units 10 such that the detection signal is output directed toward the front direction of the electronic device 100 through beamforming.

To this end, the memory 130 may include a beamforming filter set corresponding to the front direction of the electronic device 100.

Here, the beamforming filter set may include a plurality of beamforming filters. The beamforming filters may be filters for processing a sound signal to focus it at a specific location.

In addition, the number of beamforming filters included in the beamforming filter set may be the same as the number of the plurality of tweeter units. Further, each of the plurality of beamforming filters included in the beamforming filter set may correspond to each of the plurality of tweeter units. In other words, the sound signal passed through the beamforming filter may be output through the tweeter unit corresponding to the beamforming filter.

In other words, when a sound signal is passed through the plurality of beamforming filters included in the beamforming filter set and output through the plurality of tweeter units, a sound field may be formed such that the sound signal is focused in the front direction of the electronic device 100 due to overlap and offset between output sound signals. To this end, the coefficients of the plurality of beamforming filters included in the beamforming filter set may be preset such that the sound signal is focused in the front direction of the electronic device 100.

Accordingly, the processor 140 may output the detection signal through the plurality of tweeter units 10 in the front direction of the electronic device 100 using the beamforming filter set.

Specifically, the processor 140 may input the detection signal to each of the plurality of beamforming filters. For example, the processor 140 may generate a plurality of detection signals using a buffer or the like, and input the plurality of detection signals into the plurality of beamforming filters.

The processor 140 may then output the plurality of detection signals that passed through the plurality of beamforming filters through the plurality of tweeter units 10.

As such, the processor 140 may output a detection signal using beamforming.

Meanwhile, the processor 140 may receive a detection signal output through the plurality of tweeter units 10 through a plurality of microphones included in the microphone array 120 (S412).

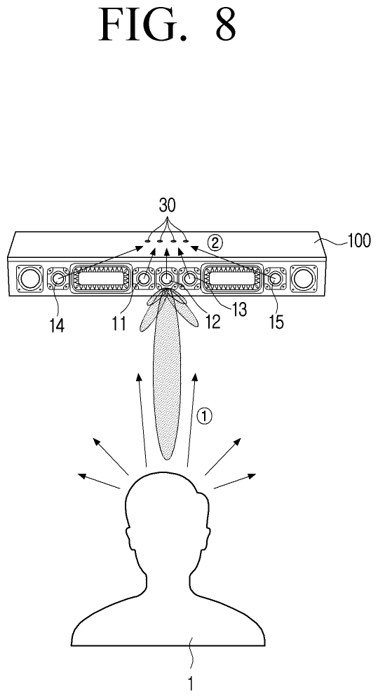

For example, as shown in FIG. 8, the processor 140 may output a detection signal through the plurality of tweeter units 11 to 15 using beamforming.

In this case, the detection signal is focused at a specific location in the front direction of the electronic device 100, such that the output detection signal is directed at the user 1 who is in the front direction of the electronic device 100. In this case, the output detection signal may be reflected by the user 1 and received through the plurality of microphones 30 (\textcircled{1}) in FIG. 8).

Furthermore, due to the side lobe generated during beamforming, the output detection signal may be received directly through the plurality of microphones 30 located around the plurality of tweeter units 11 to 15 (\textcircled{2}) in FIG. 8).

The processor 140 may then identify a distance between the electronic device 100 and the user using the output detection signal and the received detection signal (S413).

Specifically, the processor 140 may identify a distance between the electronic device 100 and the user based on a time at which the output detection signal is received through the plurality of microphones and a time at which the output detection signal is reflected by the user and received through the plurality of microphones.

In this case, the processor 140 may identify the time of flight (ToF) of the received detection signal.

Specifically, when the detection signal output through the plurality of tweeter units 10 is received directly through the plurality of microphones, the processor 140 may determine the ToF of the received detection signal. Further, when the detection signal output through the plurality of tweeter units 10 is reflected by the user and received through the plurality of microphones, the processor 140 may determine the ToF of the received detection signal.

In this case, the processor 140 may identify the ToF of the detection signal using a correlation between the output detection signal and the received detection signal.

For example, the processor 140 may calculate a cross correlation function between the output detection signal and the received detection signal. Since the cross correlation function is a function that indicates the degree of correlation between two functions, the cross correlation function between the output detection signal and the received detection signal can output a value that is proportional to the correlation between the two signals.

In this case, the processor 140 may identify a point in time when the value of the calculated cross-correlation function is maximized. The processor 140 may then identify the time from when the detection signal is output to when the value of the cross-correlation function is maximized as the ToF of the detection signal.

Alternatively, the processor 140 may identify a point in time when the value of the calculated cross-correlation function exceeds a preset threshold value. The processor 140 may then identify the time from when the detection signal is output to when the value of the cross-correlation function exceeds the preset threshold as the ToF of the detection signal.

As such, the processor 140 may obtain the ToF of the detection signal using the correlation.

Subsequently, the processor 140 may identify the distance between the electronic device 100 and the user based on the distance between the speaker array 110 and the microphone array 120 and the ToF of the detection signal.

Specifically, a ratio between the ToF of the detection signal output through the plurality of tweeter units 10 and received through the plurality of microphones and the ToF of the detection signal output through the plurality of tweeter units 10 and reflected by the user and received through the plurality of microphones may be equal to a ratio between the distance between the plurality of tweeter units 10 and the plurality of microphones and the distance between the electronic device 100 and the user.

Here, the distance between the plurality of tweeter units 10 and the plurality of microphones may be a preset value based on the positions of the plurality of tweeter units 10 and the positions of the plurality of microphones in the electronic device 100, and information about such a distance may be stored in the memory 130.

Accordingly, the processor 140 may determine the distance between the electronic device 100 and the user by applying a ratio between the ToF of the detection signal output through the plurality of tweeter units 10 and received through the plurality of microphones and the ToF of the detection signal output through the plurality of tweeter units 10 and reflected by the user and received through the plurality of microphones to the distance between the plurality of tweeter units 10 and the plurality of microphones.

Meanwhile, the processor 140 may also determine the distance between the electronic device 100 and the user based on the distance identified using the detection signal and the level (i.e., size) of the voice signal received through the plurality of microphones.

For example, it is assumed that a user voice uttered by the user is received through the plurality of microphones at a time when the detection signal is reflected by the user and received through the plurality of microphones. In this case, the processor 140 may match information about the level of the voice signal received through the plurality of microphones to the distance identified using the detection signal and store it in the memory 130.

Subsequently, when the voice signal is received through the plurality of microphones, the processor 140 may compare the level of the received voice signal to the level stored in the memory 130, identify a ratio between the levels, and apply the identified ratio to the distance stored in the memory 130 to identify the distance between the electronic device 100 and the user. In this way, the processor 140 may identify the distance between the electronic device 100 and the user using the information stored in the memory 130 without using the detection signal.

For example, it is assumed that the level of the voice signal stored in the memory 130 is A and the distance is D. Subsequently, when the voice signal is received through the plurality of microphones, the processor 140 may identify the level of the received voice signal. In this case, when the level of the received voice signal is a/2, the processor 140 may identify that the distance between the user who is currently speaking and the electronic device 100 is d/2.

Meanwhile, in the above-described embodiment, the detection signal is output using the plurality of tweeter units 10. However, this is only an example, and the processor 140 may also output the detection signal through the plurality of tweeter units 10 and the plurality of midrange units 20 using beamforming. To this end, beamforming filters corresponding to the number of speaker units used for beamforming may be stored in the memory 130.

The processor 140 may then output a sound signal through beamforming based on the identified distance (S420).

Specifically, the processor 140 may control the speaker array 110 to output R-channel signals and L-channel signals through beamforming based on the identified distance. For example, the processor 140 may control the plurality of tweeter units 10 to output R-channel signals and L-channel signals through beamforming based on the identified distance.

To this end, the memory 130 may include a plurality of beamforming filter sets corresponding to a plurality of distances. The beamforming filters may be filters for processing a sound signal to focus it at a specific location.

In addition, the number of beamforming filters included in a beamforming filter set may be the same as the number of the plurality of tweeter units. Further, each of the plurality of beamforming filters included in the beamforming filter set may correspond to each of the plurality of tweeter units. In other words, the sound signal passed through a beamforming filter may be output through a tweeter unit corresponding to the beamforming filter.

In other words, when a sound signal is passed through the plurality of beamforming filters included in the beamforming filter set and output through the plurality of tweeter units, a sound field may be formed such that the sound signal is focused at a distance corresponding to the beamforming filter set due to overlap and offset between output sound signals. To this end, the coefficients of the plurality of beamforming filters included in the beamforming filter set may be preset such that the sound signal is focused at a specific distance.

In this case, the memory 130 may include a beamforming filter set for R-channel signals and a beamforming filter set for L-channel signals for each of the plurality of distances.

Here, the coefficients of the plurality of beamforming filters included in the beamforming filter set for R-channel signals may be preset such that the sound signal is focused at a location of the right ear of the user located at a point a certain distance from the electronic device 100. Further, the coefficients of the plurality of beamforming filters included in the beamforming filter set for L-channel signals may be preset such that the sound signal is focused at a location of the left ear of the user located at a point a specific distance away from the electronic device 100.

Accordingly, the R-channel signals output after passing through the beamforming filter set for the R-channel signals may enter the user's right ear located a specific distance away from the electronic device 100, and the L-channel signals output after passing through the beamforming filter set for the L-channel signals may enter the user's left ear located a specific distance away from the electronic device 100.

The processor 140 may control the speaker array 110 to output the R-channel signals and the L-channel signals using a beamforming filter set corresponding to the distance between the electronic device 100 and the user among a plurality of beamforming filter sets stored in the memory 130.

To this end, the processor 140 may identify a beamforming filter set for the R-channel signals and a beamforming filter set for the L-channel signals that correspond to the distance between the electronic device 100 and the user among a plurality of beamforming filter sets stored in the memory 130.

Subsequently, the processor 140 may input the R-channel signals to each of the plurality of beamforming filters included in the beamforming filter set for the R-channel signals. For example, the processor 140 may generate a plurality of R-channel signals using a buffer or the like, and input the plurality of R-channel signals to the plurality of beamforming filters. The processor 140 may then output the plurality of R-channel signals that passed through the plurality of beamforming filters through the plurality of tweeter units 10.

Further, the processor 140 may input the L-channel signals to each of a plurality of beamforming filters included in the beamforming filter set for the L-channel signals. For example, the processor 140 may generate a plurality of L-channel signals using a buffer or the like, and input the plurality of L-channel signals to the plurality of beamforming filters. The processor 140 may then output the plurality of L-channel signals that passed through the plurality of beamforming filters through the plurality of tweeter units 10.

Accordingly, the R-sound signals and the L-sound signals output from the electronic device 100 may be focused at a point where the user is located in the front direction of the electronic device 100, thereby providing a stereophonic sound effect to the user.

Meanwhile, in the above-described embodiment, the R-channel signals and the L-channel signals are output using the plurality of tweeter units 10. However, this is only an example, and the processor 140 may also output the R-channel signals and the L-channel signals through the plurality of tweeter units 10 and the plurality of midrange units 20 using beamforming. To this end, beamforming filters corresponding to the number of speaker units used for beamforming may be stored in the memory 130.

Meanwhile, the beam width and beam angle of the R-channel signals and the L-channel signals may be determined according to the beamforming filter set corresponding to the distance of the electronic device 100 and the user.

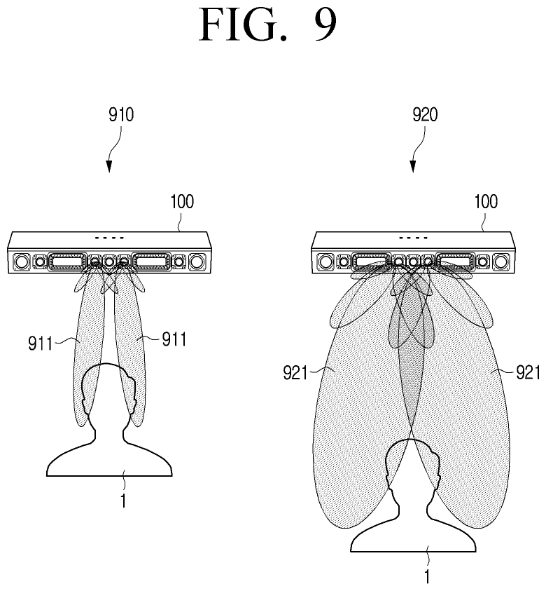

The beamformed sound signal must be focused at a point a specific distance away from the electronic device 100. Accordingly, as shown in 910 of FIG. 9, when the user 1 is located at a close distance, a beam 911 formed by the beamformed sound signal may be formed so as to provide stereoscopic sound to the user located at the close distance without crosstalk. Also, as shown in 920 of FIG. 9, when the user 1 is located at a far distance, a beam 921 formed by the beamformed sound signal may be formed so as to provide stereoscopic sound to the user located at the far distance without crosstalk.

In this case, the beam width and beam angle of the beam formed by the electronic device 100 may be narrower when the user is located at a close distance than when the user is located at a far distance.

According to an embodiment, even when the user is located at a far distance, a sharp beam (i.e., a beam with a narrow beam width) may be formed at a narrow beam angle to provide stereoscopic sound to the user located at the far distance. However, many speaker units are required to form a sharp beam. Therefore, according to an embodiment, considering the number of speaker units, the beam angle may be widened and the beam width may be adjusted according to the widened beam angle to provide stereoscopic sound to the user located at the far distance.

Meanwhile, the methods according to an embodiment may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., Play Store™) or directly between two user devices (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory of a relay server or may be temporarily generated.

Further, the components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration.

Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Meanwhile, terms “unit” or “module” used in the disclosure may include units configured by hardware, software, or firmware, and may be used compatibly with terms such as, for example, logics, logic blocks, parts, circuits, or the like. The “unit” or “module” may be an integrally configured part or a minimum unit performing one or more functions or a part thereof. For example, the module may be configured by an application-specific integrated circuit (ASIC).

Meanwhile, a non-transitory computer readable medium storing a program for sequentially performing the method for outputting sound according to the present disclosure may be provided. The non-transitory computer-readable medium refers to a medium that stores data semi-permanently and can be read by a device, rather than a medium that stores data for a short period of time, such as registers, caches, memory, etc. Specifically, the above-described various applications or programs may be stored and provided in a non-transitory computer-readable medium such as CD, DVD, hard disk, Blu-ray disk, USB, memory card, ROM, etc.

In addition, various embodiments of the present disclosure may be implemented in software including an instruction stored in a machine-readable storage medium (e.g., computer). The machine may be a device that invokes the stored instruction from the storage medium and can be operated based on the invoked instruction, and may include an electronic device (e.g., robot 100) according to the embodiments disclosed herein.

In case that the instruction is executed by the processor, the processor may directly perform a function corresponding to the instruction or other components may perform the function corresponding to the instruction under control of the processor. The instruction may include codes generated or executed by a compiler or an interpreter.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

1. An electronic device comprising:
a speaker array;
a microphone array including a plurality of microphones;
a memory to store at least one instruction; and
one or more processors to be connected to the speaker array, the microphone array and the memory to control the electronic device, while connected, the one or more processors, by executing the at least one instruction, are configured to:
identify a user direction based on a user voice of a user that is received through the plurality of microphones,
based on the user direction being identified as a front direction of the electronic device, control the speaker array to output a sound signal in a first output mode, and
based on the user direction being identified as not the front direction of the electronic device, control the speaker array to output the sound signal in a second output mode;
wherein the first output mode is a mode in which an R-channel signal and an L-channel signal are output using beamforming, and the second output mode is a mode in which the R-channel signal and the L-channel signal are used to provide a sound field having a wider sweet spot than in the first output mode.

2. The electronic device as claimed in claim 1, wherein the one or more processors are configured to:
based on the user direction being identified as the front direction of the electronic device, control the speaker array to directionally output the R-channel signal toward a right ear of the user and directionally output the L-channel signal toward a left ear of the user using the beamforming.

3. The electronic device as claimed in claim 1, wherein the one or more processors are configured to:
based on the user direction being identified as the front direction of the electronic device, identify a distance between the electronic device and the user, and control the speaker array to output the R-channel signal and the L-channel signal through the beamforming according to the identified distance.

4. The electronic device as claimed in claim 3, wherein the one or more processors are configured to:
based on the user direction being identified as the front direction of the electronic device, control the speaker array to output a detection signal, and identify a distance between the electronic device and the user based on a time at which the output detection signal is received through the plurality of microphones and a time at which the output detection signal is reflected by the user and received through the plurality of microphones.

5. The electronic device as claimed in claim 3, wherein the one or more processors are configured to control the speaker array to directionally output a detection signal toward the front direction of the electronic device through the beamforming.

6. The electronic device as claimed in claim 3, wherein the memory includes a plurality of beamforming filter sets corresponding to a plurality of distances; and
wherein the one or more processors are configured to:
identify a beamforming filter set corresponding to the identified distance among the plurality of beamforming filter sets, input the R-channel signal and the L-channel signal to a plurality of beamforming filters included in the identified beamforming filter set, and output the R-channel signal and the L-channel signal that passed through the plurality of beamforming filters through the speaker array; and
wherein a beam width and a beam angle of the R-channel signal and the L-channel signal are determined according to a beamforming filter set corresponding to the identified distance.

7. The electronic device as claimed in claim 1, wherein the speaker array includes a plurality of speaker units; and
wherein the plurality of speaker units include a plurality of tweeter units that output a high-range sound signal above a threshold frequency and a plurality of mid-range units that output a low-and mid-range sound signal below the threshold frequency.

8. The electronic device as claimed in claim 7, wherein the plurality of tweeter units include a plurality of first tweeter units at a center portion of the speaker array and a plurality of second tweeter units spaced apart to a right and a left of the plurality of first tweeter units; and
wherein the plurality of mid-range units are disposed on one side of the plurality of second tweeter units.

9. The electronic device as claimed in claim 8, wherein the plurality of first tweeter units include a plurality of tweeter units that are disposed in a row;
wherein the plurality of second tweeter units include a left tweeter unit disposed to the left of the plurality of first tweeter units and a right tweeter unit disposed to the right of the plurality of first tweeter units; and
wherein the plurality of mid-range units include a first mid-range unit disposed to the left of the left tweeter unit and a second mid-range unit disposed to the right of the right tweeter unit.

10. A method for outputting sound of an electronic device that includes a speaker array and a microphone array including a plurality of microphones, the method comprising:
identifying a user direction based on a user voice of a user that is received through the plurality of microphones; and
based on the user direction being identified as a front direction of the electronic device, controlling the speaker array to output a sound signal in a first output mode,
based on the user direction being identified as not the front direction of the electronic device, controlling the speaker array to output the sound signal in a second output mode,
wherein the first output mode is a mode in which an R-channel signal and an L-channel signal are output using beamforming, and the second output mode is a mode in which the R-channel signal and the L-channel signal are used to provide a sound field having a wider sweet spot than in the first output mode.

11. The method as claimed in claim 10, wherein
based on the user direction being the front direction of the electronic device, controlling the speaker array to directionally output the R-channel signal toward a right ear of the user and directionally output the L-channel signal toward a left ear of the user using the beamforming.

12. The method as claimed in claim 10, wherein
based on the user direction being the front direction of the electronic device, identifying a distance between the electronic device and the user, and controlling the speaker array to output the R-channel signal and the L-channel signal through the beamforming according to the identified distance.

13. The method as claimed in claim 12, further comprising:
based on the user direction being the front direction of the electronic device, controlling the speaker array to output a detection signal; and
identifying a distance between the electronic device and the user based on a time at which the output detection signal is received through the plurality of microphones and a time at which the output detection signal is reflected by the user and received through the plurality of microphones.

14. The method as claimed in claim 12, comprising:
controlling the speaker array to directionally output a detection signal toward the front direction of the electronic device through the beamforming.

15. The method as claimed in claim 12, comprising:
identifying a beamforming filter set corresponding to the identified distance among a plurality of beamforming filter sets corresponding to a plurality of distances, inputting the R-channel signal and the L-channel signal to a plurality of beamforming filters included in the identified beamforming filter set, and outputting the R-channel signal and the L-channel signal that passed through the plurality of beamforming filters through the speaker array, and
wherein a beam width and a beam angle of the R-channel signal and the L-channel signal are determined according to the beamforming filter set corresponding to the identified distance.

16. A non-transitory computer readable recording medium storing computer instructions for an electronic device to perform an operation when executed by one or more processor of the electronic device which comprises a speaker array and a microphone array including a plurality of microphones, wherein the operation comprises:
identifying a user direction based on a user voice of a user that is received through the plurality of microphones; and
based on the user direction being identified as a front direction of the electronic device, controlling the speaker array to output a sound signal in a first output mode, based on the user direction being identified as not the front direction of the electronic device, controlling the speaker array to output the sound signal in a second output mode,
wherein the first output mode is a mode in which an R-channel signal and an L-channel signal are output using beamforming; and wherein the second output mode is a mode in which the R-channel signal and the L-channel signal are used to provide a sound field having a wider sweet spot than in the first output mode.

17. A non-transitory computer readable recording medium of claim 16, wherein based on the user direction being the front direction of the electronic device, controlling the speaker array to directionally output the R-channel signal toward a right ear of the user and directionally output the L-channel signal toward a left ear of the user using the beamforming.

18. A non-transitory computer readable recording medium of claim 16, wherein based on the user direction being the front direction of the electronic device, identifying a distance between the electronic device and the user, and controlling the speaker array to output the R-channel signal and the L-channel signal through the beamforming according to the identified distance.

19. A non-transitory computer readable recording medium of claim 18, further comprising:
based on the user direction being the front direction of the electronic device, controlling the speaker array to output a detection signal; and
identifying a distance between the electronic device and the user based on a time at which the output detection signal is received through the plurality of microphones and a time at which the output detection signal is reflected by the user and received through the plurality of microphones.

20. A non-transitory computer readable recording medium of claim 18, comprising:
controlling the speaker array to directionally output a detection signal toward the front direction of the electronic device through the beamforming.
